(19) United States
(12) Patent Application Publication
(10) Pub. No.: US 2021/0098156 A1
(43) Pub. Date: Apr. 1, 2021

(54) CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: DUO CHEN, Kunshan (CN); JUAN ZHENG, Kunshan (CN); LU-YU CHANG, New Taipei (TW)

(21) Appl. No.: 17/033,595

(22) Filed: Sep. 25, 2020

(30) Foreign Application Priority Data
Sep. 29, 2019 (CN) 201921646618.X

(51) Int. Cl. H01B 11/10; H01B 17/58

(52) U.S. Cl. CPC H01B 11/1033; H01B 7/0216; H01B 11/1091; H01B 17/58

(57) ABSTRACT

A cable includes: a core wire including an inner conductor and an insulating layer around the inner conductor by extrusion molding; a shielding layer covering the core wire; and an outer insulating layer covering the shielding layer; wherein the shielding layer is silver-plated copper foil, and there is no insulating layer between the core wire and the silver-plated copper foil.

### BACKGROUND OF THE INVENTION

### 1. Field of the Invention

The present invention relates generally to a cable, and more particularly to a high frequency cable that uses silver-plated copper foil as a shield layer.

### 2. Description of Related Arts

With the development and popularization of electronic technology products, signal cables are widely used in household appliances, instrumentation, automation equipment, data centers, servers, switches, cloud computing and 5G as a tool for signal transmission. However, in the signal transmission process, the cable is very susceptible to interference from external electromagnetic signals, so it is often necessary to use a shielding structure to eliminate or reduce the interference of the external electromagnetic field, and to prevent the leakage of the transmission signal.

Therefore, it is necessary to provide an improved cable with strong anti-interference performance, stable signal transmission, reliability and simple manufacturing.

### SUMMARY OF THE INVENTION

A main object of the present invention is to provide a cable, which has good shielding effect and stable signal transmission capability.

To achieve the above-mentioned object, a cable comprises: a core wire including an inner conductor and an insulating layer around the inner conductor by extrusion molding; a shielding layer covering the core wire; and an outer insulating layer covering the shielding layer; wherein the shielding layer is silver-plated copper foil, and there is no insulating layer between the core wire and the silver-plated copper foil.

Compared to the prior art, the present invention has the advantage that the use of silver-plated copper foil as the shielding layer increases the shielding effect of the signal cable so that signal cable is protected from external interference when transmitting signals and ensures the reliability of signal transmission, at the same time, the cable of the present invention has the ability to transmit high-speed data signals with a frequency greater than 42 GHz.

### BRIEF DESCRIPTION OF THE DRAWING

FIG. 1 is a cross-section view of the first embodiment of the cable of the present invention;

FIG. 2 is a cross-section view of the second embodiment of the cable of the present invention;

FIG. 3 is a cross-section view of the third embodiment of the cable of the present invention;

FIG. 4 is a cross-section view of the fourth embodiment of the cable of the present invention;

FIG. 5 is a cross-section view of the fifth embodiment of the cable of the present invention;

FIG. 6 is a cross-section view of the sixth embodiment of the cable of the present invention;

FIG. 7 is a cross-section view of the seventh embodiment of the cable of the present invention;

FIG. 8 is a cross-section view of the eighth embodiment of the cable of the present invention;

FIG. 9 is a cross-section view of the ninth embodiment of the cable of the present invention;

FIG. 10 is a cross-section view of the tenth embodiment of the cable of the present invention;

FIG. 11 is a cross-section view of the eleventh embodiment of the cable of the present invention;

FIG. 12 is the differential insertion loss curve obtained by using the structure in FIG. 4 and American Wire Gauge No. 28 (28AWG) test;

FIG. 13 is the change trend graph of the differential insertion loss obtained by using the structure in FIG. 4 and the 28AWG test;

FIG. 14 is the differential to common mode conversion loss curve obtained by using the structure in FIG. 4 and the 28AWG test; and

FIG. 15 is the differential to common-mode conversion loss minus the differential insertion loss obtained by using the cable structure of FIG. 4 and the 28AWG test.

### DETAILED DESCRIPTION OF THE PREFERRED EMBODIMENT

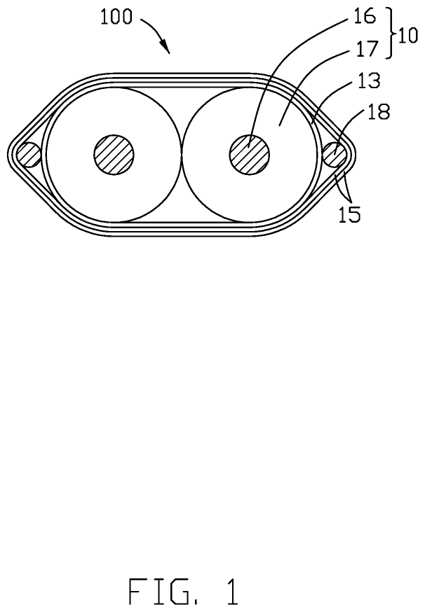

Referring to FIG. 1, which is the first embodiment of the cable 100 of the present invention. The cable 100 includes a pair of core wires 10, a silver-plated copper foil shielding layer 13 covers the pair of core wires 10, an outer insulating layer 15 covers the silver-plated copper foil shielding layer 13, and two ground wires 18 located between the silver-plated copper foil shielding layer 13 and the outer insulating layer 15.

In this embodiment, the two core wires 10 are parallel and longitudinally arranged. Each of the core wire 10 includes an inner conductor 16 and an insulating layer 17 covering the inner conductor 16, and the inner conductor 16 is used for transmitting high-speed signal. The insulating layer 17 of the core wire 10 is extruded and molded to cover the inner conductor 16. The insulating layer 17 separates the inner conductor 16 and the silver-plated copper foil shielding layer 13. The main purpose of the insulating layer 17 is to prevent the inner conductor 16 from being exposed and causing the risk of short circuit. The silver-plated copper foil serves as the shielding layer of the cable 100, which includes a PET (polyethylene terephthalate) layer, a copper foil layer and a silver-plated layer. The silver-plated copper foil shielding layer 13 uses a PET layer as a substrate, a layer of copper foil is calendered on the PET substrate, and then a silver-plated layer is plated on the copper foil layer. The silver-plated copper foil shielding layer 13 wraps the core wire 10 in a spiral winding manner. Of course, the silver-plated copper foil shielding layer 13 can also wrap the core wire 10 in a longitudinally wrapped manner. The outer insulating layer 15 is set in two layers, and its material can be heat seal PET material. The outer insulating layer 15 is wound laterally around the silver-plated copper foil shielding layer 13, and the two layers of outer insulating layer 15 are wound in different directions. Of course, the outer insulating layer 15 can also be longitudinally covered on the silver-plated copper foil shielding layer 13. The two ground wires 18 are respectively arranged on the left and right sides of the silver-plated copper foil shielding layer 13, approximately on the extension line of the center line of the two inner conductors 16.

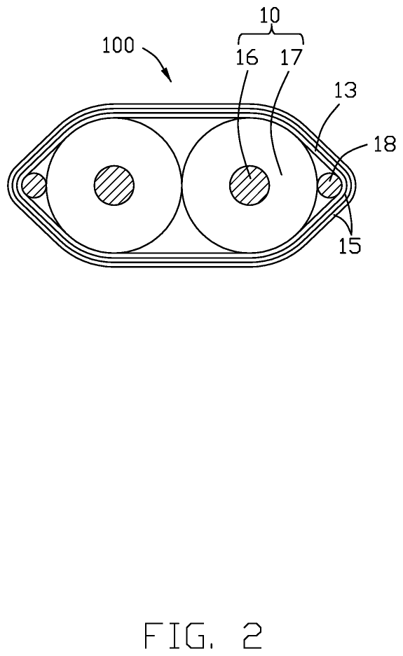

Please refer to FIG. 2, which is the second embodiment of the cable 100 of the present invention. Compared with the first embodiment, in this embodiment, only the two ground wires 18 are arranged between the core wire 10 and the silver-plated copper foil shielding layer 13, and the others are unchanged.

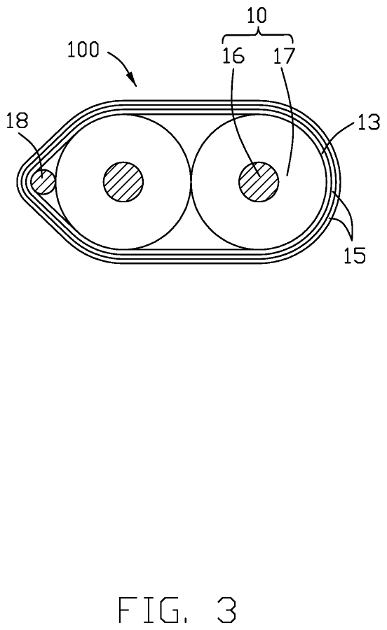

Please refer to FIG. 3, which is the third embodiment of the cable 100 of the present invention. Compared with the second embodiment, in this embodiment, there is only one ground wire 18 in this embodiment.

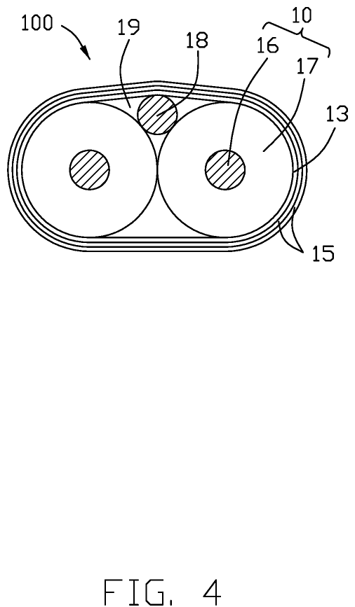

Please refer to FIG. 4, which is the fourth embodiment of the cable 100 of the present invention. Compared with the third embodiment, in this embodiment, the ground wire 18 is arranged in the air gap 19 between the insulating layer 17 and the silver-plated copper foil shielding layer 13.

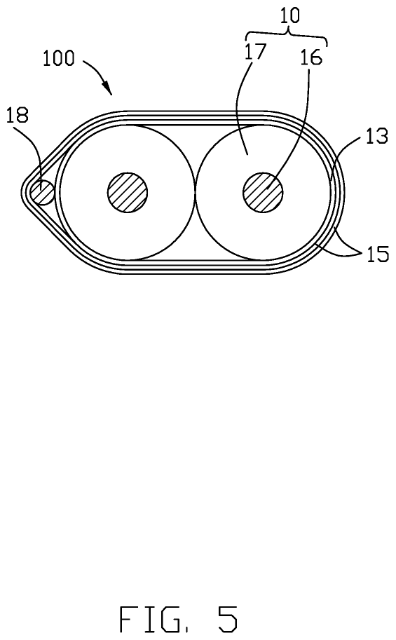

Please refer to FIG. 5, which is the fifth embodiment of the cable 100 of the present invention. Compared with the first embodiment, in this embodiment, there is only one ground wire 18 in this embodiment.

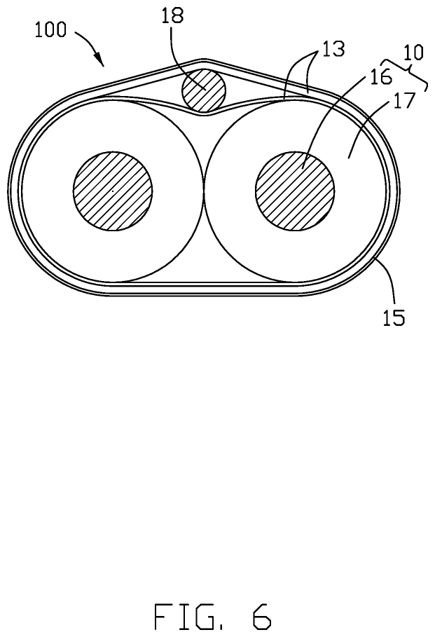

Please refer to FIG. 6, which is the sixth embodiment of the cable 100 of the present invention. Compared with the fourth embodiment, in this embodiment, there are two layers of silver-plated copper foil shielding layer 13, the first layer is covered with two core wires 10 in a longitudinal manner, and the second layer is wrapped around the first layer of silver-plated copper foil shielding layer 13 in a spiral winding manner. A ground wire 18 is placed in the middle of the upper side between the two silver-plated copper foils shielding layer 13.

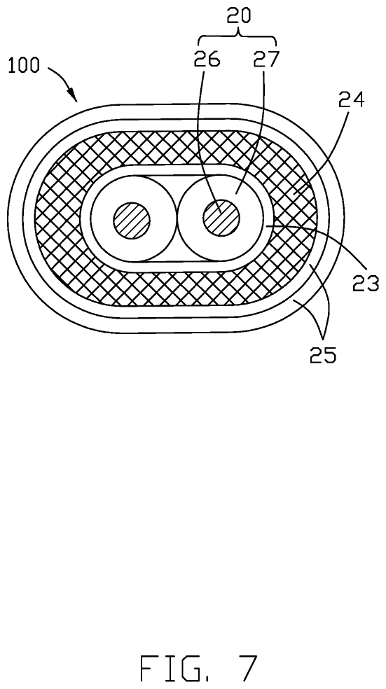

Referring to FIG. 7, which is the seventh embodiment of a cable 100 of the present invention. The cable 100 includes a pair of core wires 20, a silver-plated copper foil shielding layer 23 covers the pair of core wires 20, a braided shield layer 24 covers the silver-plated copper foil shielding layer 23 and an outer insulating layer 25 covers the braided shield layer 24. In this embodiment, each of the core wire 20 includes an inner conductor 26 and an insulating layer 27 covering the inner conductor 26, the insulating layer 27 is covered around the inner conductor 26 by extrusion molding, and the two inner conductors 26 are respectively located in the extruded insulating layer 27. In this embodiment, the ground wire is omitted, and the braided shield layer 24 outside the silver-plated copper foil 23 is used for grounding. The outer insulating layer 25 is set in two layers, and its material can be hot-bonded PET material. The outer insulating layer 25 is wound laterally around the silver-plated copper foil shielding layer 23, and the two layers of outer insulating layer 25 are wound in different directions. Of course, the outer insulating layer 25 can also be longitudinally covered on the silver-plated copper foil shielding layer 23.

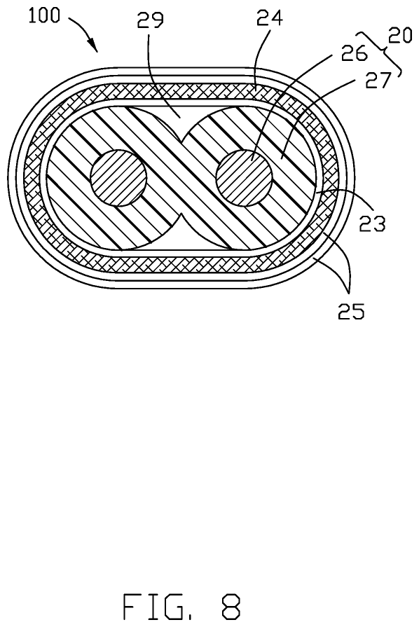

Please refer to FIG. 8, which is the eighth embodiment of the cable 100 of the present invention. Compared with the seventh embodiment, in this embodiment, the core wire 20 includes two inner conductors 26 and an insulating layer 27 that is extruded and coated simultaneously on the two inner conductors 26. The core wire 20 is roughly in the shape of glasses. The silver-plated copper foil shielding layer 23 is wrapped around the insulating layer 27 of the core wire 20 and there are air gaps 29 between the insulating layer 27 and the silver-plated copper foil shielding layer 23.

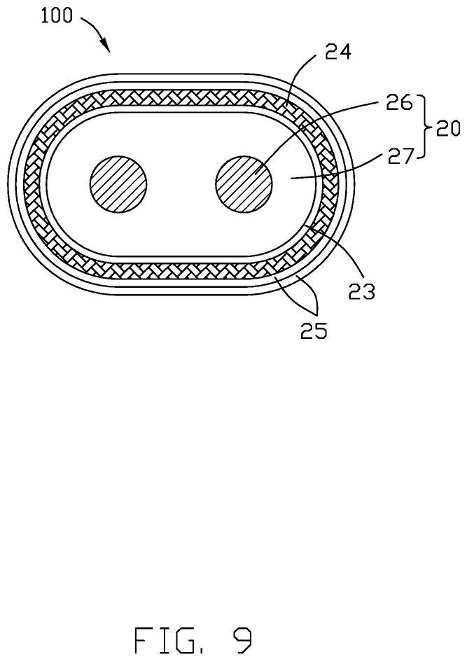

Please refer to FIG. 9, which is the ninth embodiment of the cable 100 of the present invention. Compared with the eighth embodiment, in this embodiment, the insulating layer 27 of the core wire 20 wraps around the two inner conductors 26 in a racetrack shape, and there is no air gap between the insulating layer 27 of the core wire 20 and the silver-plated copper foil shielding layer 23.

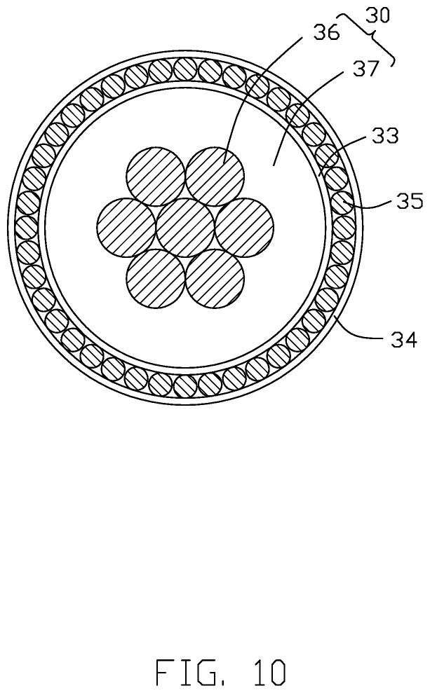

Please refer to FIG. 10, which is the tenth embodiment of the cable 100 of the present invention. The cable 100 includes a core wire 30, a silver-plated copper foil shielding layer 33 covering the core wire 30, a braided shielding layer 34 covering the silver-plated copper foil shielding layer 33, and an outer insulating layer 35 covering the braided shielding layer 34. The core wire 30 includes plurality of inner conductors 36 and an insulating layer 37 covering the inner conductors 36, and the insulating layer 37 is wrapped around the inner conductors 36 by extrusion molding. In this embodiment, the inner conductors 36 are clustered together, and the plurality of inner conductors 36 are arranged in parallel and longitudinally. The insulating layer 37 is extruded and molded and simultaneously covered on the multiple inner conductors 36.

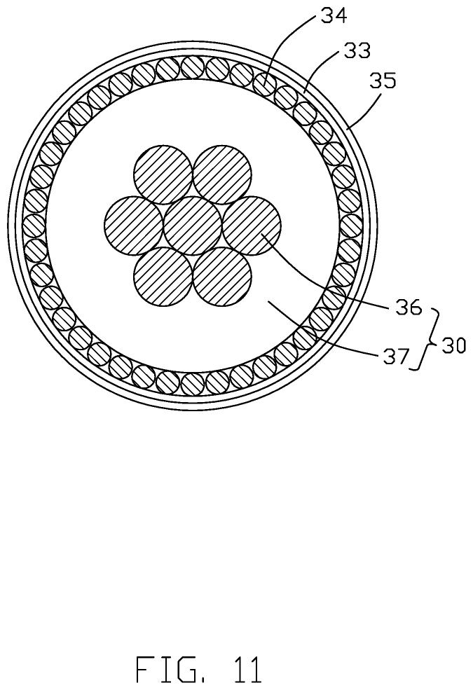

Please refer to FIG. 11, which is the eleventh embodiment of the cable 100 of the present invention. Compared with the tenth embodiment, in this embodiment, the positions of the silver-plated copper foil shielding layer 33 and the braided shielding layer 34 are interchanged, that is, the braided shielding layer 34 is arranged outside the core wire 30, and the silver-plated copper foil shielding layer 33 is wrapped outside the braided shielding layer 34.

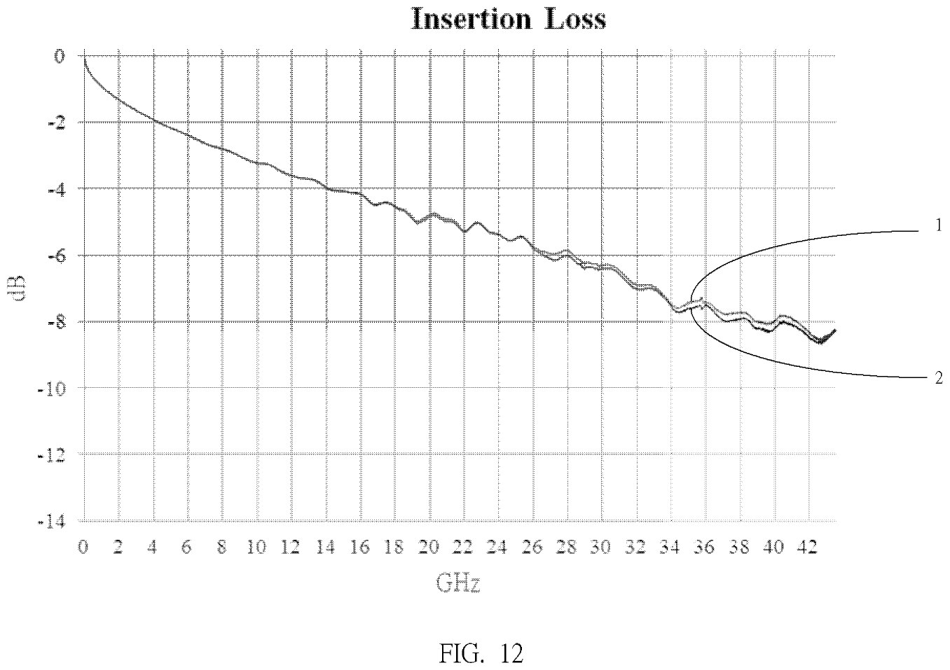

Please refer to FIGS. 12-15, which shows some performance test curves of the silver-plated copper foil applied to the cable. Use the cable structure in the fourth embodiment above-mentioned and American wire gauge 28 (28AWG) as the test sample. To facilitate the observation of the test results, use two identical cables. Record the curve measured by the first cable as curve 1, and record the curve measured by the second cable as curve 2. The abscissa is the frequency, the unit is GHz, the ordinate is the loss, the unit is dB. FIG. 12 is the SDD21 (differential insertion loss) curve of two cables. It can be seen that as the frequency increases, the differential insertion loss has no cliff-like attenuation before 42 GHz.

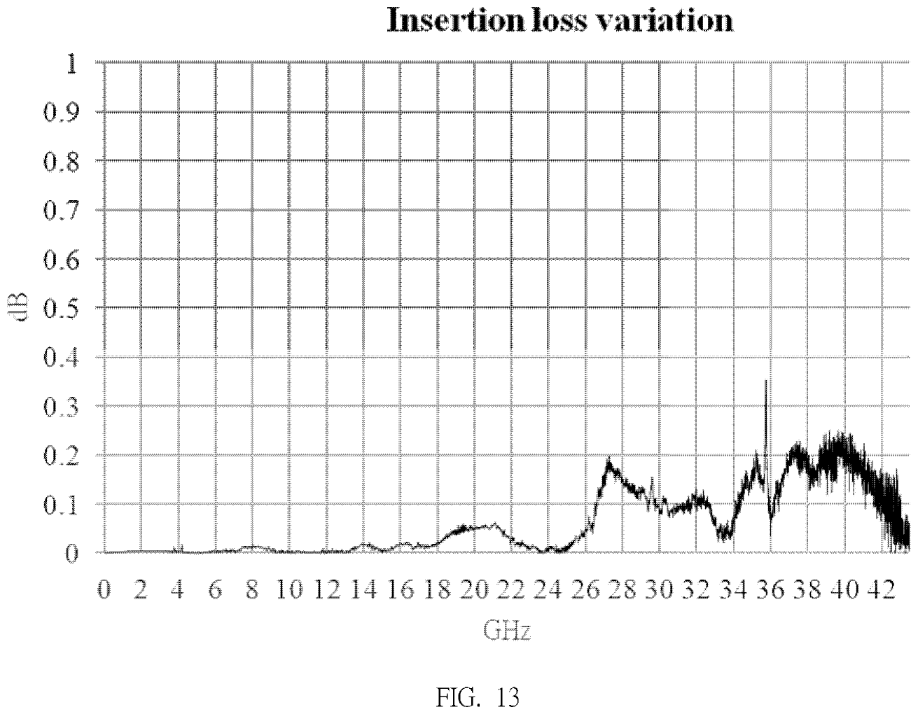

FIG. 13 shows the variation trend of the differential insertion loss of the two cables. It can be seen that the insertion loss trend of the two cables before 25 GHz is less than 0.1 dB/M, and the cable with silver-plated copper foil shielding layer is 0.2 dB/M smaller than the cable with ordinary metal foil shielding layer.

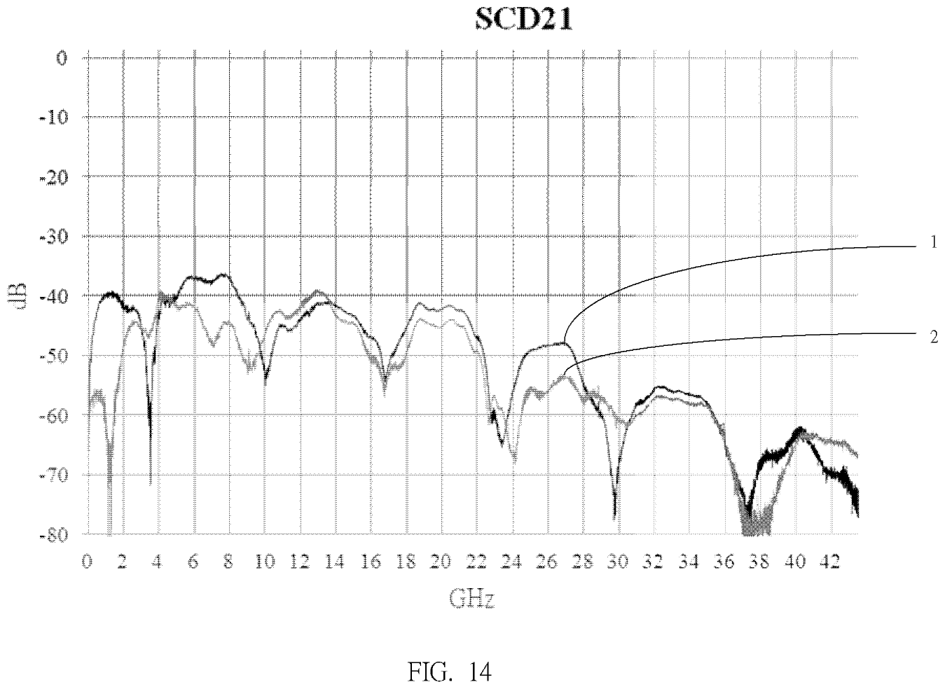

FIG. 14 is the SCD21 (differential to common-mode conversion loss) change curve, it can be seen that the SCD21 of the two cables is less than −30 dB.

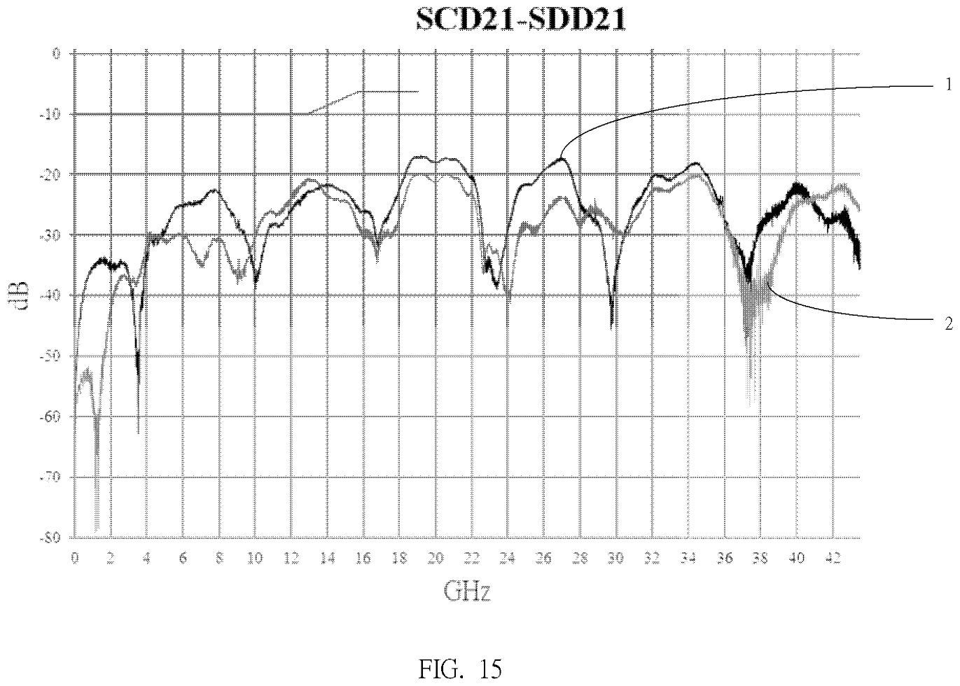

FIG. 15 is a graph of SCD21−SDD21 (differential to common-mode conversion loss−differential insertion loss). It is the value obtained by subtracting SCD21 in FIG. 14 and SDD21 in FIG. 12, and it can be seen that its value is below −10 dB.

The present invention adopts silver-plated copper foil is used as the shielding layer, and there is no insulating layer is arranged between the silver-plated copper foil shielding layer and the core wire. The shielding layer of the cable uses silver-plated copper foil has a better shielding effect, low signal transmission attenuation, the cable has a high-speed data transmission capability with a signal frequency greater than 42 GHz and has high corrosion resistance.

The above are only some of the embodiments of the present invention, but not all of the embodiments. Any equivalent changes to the technical solutions of the present invention by those skilled in the art by reading the description of the present invention are covered by the claims of the present invention.

What is claimed is:

1. A cable comprising:
a core wire including an inner conductor and an insulating layer around the inner conductor by extrusion molding;
a shielding layer covering the core wire; and
an outer insulating layer covering the shielding layer; wherein
the shielding layer is silver-plated copper foil, and there is no insulating layer between the core wire and the silver-plated copper foil.

2. The cable as claimed in claim 1, wherein the silver-plated copper foil includes a PET layer, a copper foil layer, and a silver-plated layer.

3. The cable as claimed in claim 2, wherein the silver-plated copper foil includes a PET substrate, a copper foil layer calendered on the PET substrate, and a silver-plated layer plated on the copper foil layer.

4. The cable as claimed in claim 1, further including at least one ground wire arranged between the core wire and the shielding layer.

5. The cable as claimed in claim 1, further comprising at least one ground wire arranged between the shielding layer and the outer insulating layer.

6. The cable as claimed in claim 1, further comprising a braided shielding layer arranged between the shielding layer and the core wire.

7. The cable as claimed in claim 1, further comprising a braided shielding layer arranged between the shielding layer and the outer insulating layer.

8. The cable as claimed in claim 1, wherein the shielding layer covers the core wire in a spiral winding manner or a longitudinal coating manner.

9. The cable as claimed in claim 1, wherein the cable is adapted to transmit high-speed data with a signal frequency greater than 42 GHz.

10. A cable comprising:
a core wire including an inner conductor and an insulating layer around the inner conductor by extrusion molding;
a shielding layer covering the core wire; and
an outer insulating layer covering the shielding layer; wherein
the shielding layer includes a PET substrate and a silver-plated layer commonly sandwiching a copper foil layer therebetween.

11. The cable as claimed in claim 10, wherein the PET substrate intimately surrounds the insulating layer of the core wire.

12. The cable as claimed in claim 10, further including a braided shield layer is sandwiched between the core wire and the shielding layer.

13. The cable as claimed in claim 10, further including a braided shield layer is sandwiched between the outer insulating layer and the shielding layer.
